(19) United States
(12) Patent Application Publication
(10) Pub. No.: US 2005/0027217 A1
(43) Pub. Date: Feb. 3, 2005

(54) Massaging device structure

(76) Inventor: Yi Li Tsai, Taipei (TW)

Correspondence Address: Yi Li Tsai, PO Box 82-144, Taipei, TW

(21) Appl. No.: 10/630,764

(22) Filed: Jul. 31, 2003

(51) Int. Cl. A61H 1/00; A61H 1/02; A61H 5/00

(52) U.S. Cl. 601/17

(57) ABSTRACT

A massaging device structure is disclosed. The device comprises a tubular body contains massaging lotion or cream. One end of the body is provided with a flowing tube and one side is provided with an elastic valve sealed the outlet hole at the end cap of the end head, and the lower portion of the inner portion of the tubular body is an engaging ring face for the mounting with a positioning screw element. The center of the screw element is provided with a pushing rod and the bottom end is a ring element connecting the bottom end of the massage head to the tubular body The rotating of the massaging head from the bottom end allowing the discharge lotion is constant.

### BACKGROUND OF THE INVENTION

(a) Technical Field of the Invention

The present invention relates to massaging device, and in particular, to a massaging device which discharges a massaging solution or lotion when the device is applied.

(b) Description of the Prior Art

Conventional massaging device, for instance, the massaging rod has to be designed differently for different ways of application. If a lotion or cream is to be applied in the course of massaging from the device, another container has to be attached to it and a portion of the lotion or cream has to be poured out for application. With respect to application, this is rather inconvenient, the lotion or cream may be either too much or insufficient and another application is needed.

Taiwanese Patent Publication No. 189434 entitled “A massaging rod with simultaneously releasing of a massaging lotion” discloses the device having a main body tube which contains a lotion, and the bottom end of the tube is provided with a hole for the mounting of a steel bead, and a wick or a like element is inserted to the hole. A screw nut with a hollow center together with a spring is used to push the steel bead such that when the steel bead end is compressed, the lotion will be released. However, the amount of lotion for this case is depending on the pressure that applied. The control of pressure is not easy and therefore, the amount of lotion is not easily controlled. In view of the above, it is imperative to design a massaging rod which can discharge a massaging lotion of fixed amount in the course of application.

### SUMMARY OF THE INVENTION

Accordingly, it is an object of the present invention to provide a massaging device structure having a tubular body containing a lotion, with an outlet end head at one end of the tubular body and a massaging end at other end, characterized in that a flowing tube is mounted within the outlet end head and is connected to the interior of the tubular body, one side of the tubular body is an outlet opening with an elastic valve plate being used as a stepped-like sealing cap, the inner, edge of the lower section of the tubular body is provided with a positioning screw element by means of an engaging ring face, the inner bottom edge face of the screw element is protruded with a ratchet teeth face which mounted with a ring element having a bottom end mounted to the inner bottom portion of the massaging end, and the inner bottom portion of the massaging end is protruded with a positioning rod and is inserted into a hollow slot of a pushing rod to allow pushing rod to be rotated, the ratchet teeth face of the elastic ring element and the ratchet teeth face of the positioning screw element are in engagement such that when the pushing rod is rotated to move up to discharge a solution, the valve plate is retracted and a fixed amount of lotion is squeezed, when there is no squeezing action of the valve plate restores to its position and sealed the outlet.

Yet another object of the present invention is to provide a massaging device structure, wherein the cross section of the positioning rod is similar to the shape of the hollow slot of the pushing rod and with similar or corresponding engaging side face.

Still another object of the present invention is to provide a massaging device structure, wherein a force exerted will rotatably squeeze out a fixed amount of lotion, and the elastic valve plate allows the automatic sealing of the lotion from the outlet.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of the massaging device structure in accordance with the present invention.

FIG. 2 is a schematic view of the massaging device of the present invention.

FIG. 3 is a schematic view showing the squeezing action of the massaging device structure of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

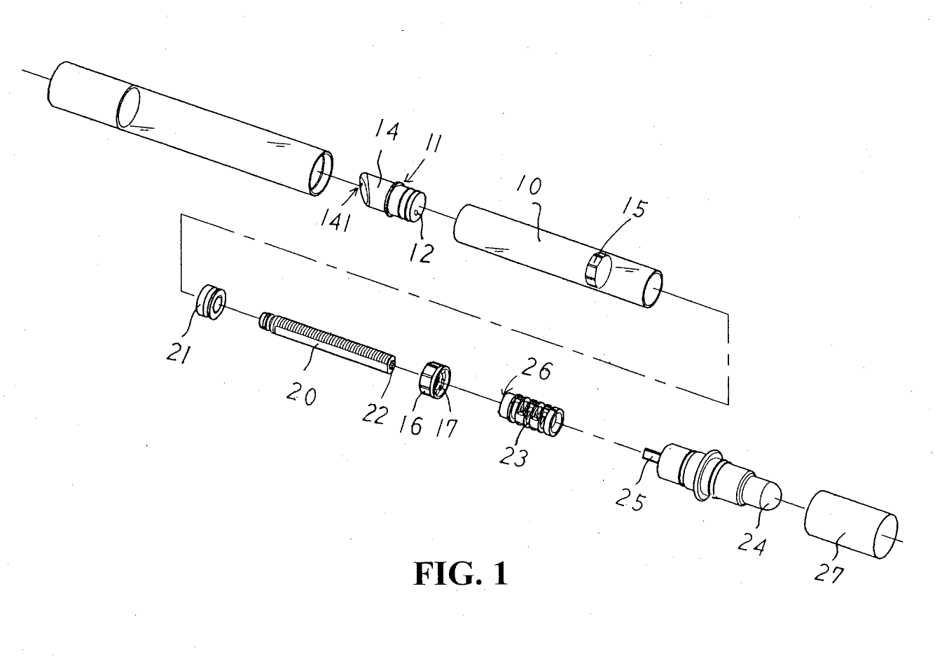

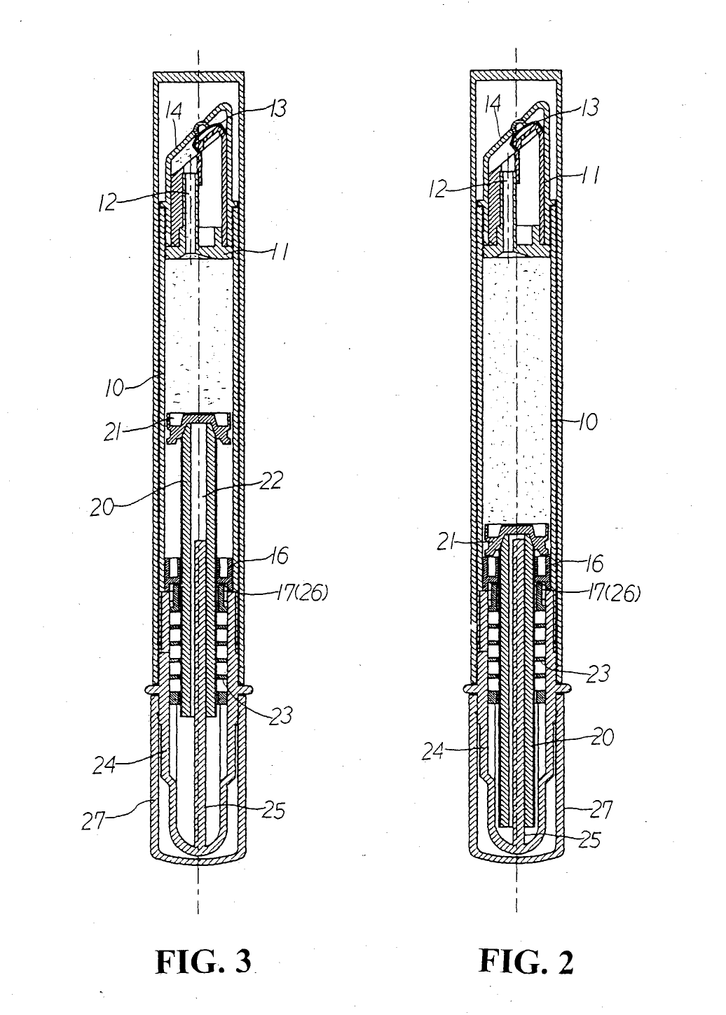

Referring to FIGS. 1 to 3, there is shown a massaging device structure of the present invention. The device comprises a tubular body 10 containing a massaging solution or lotion. One end of the tubular body is sealed by an outlet end head 11, and the interior of the end head 11 is a flowing tube 12 and is connected to the hollow interior. The side of the tubular body is mounted with a stepped-like elastic valve plate 13 and the protruded portion at the top end can be fitted to the outlet hole 141 of the external end cap 14. The elastic valve 13 elastically seals the entire hole passage so that the contained lotion will not be leaked and to further isolate sealing of the lotion from the external air. The lower portion of the tubular edge of the tubular body 10 is provided with engaging ring face 15 for mounting with a positioning screw element having the corresponding edge face. The screw hole at the center of the screw element 16 is provided for the mounting of the pushing rod 20. The top end of the pushing rod 20 is pivotally mounted with a valve plate 21 of similar radius so that the valve plate 21 moves upward with the pushing rod 20 and slides to the interior of the tubular body 10 so as to achieve squeezing operation. Further, the positioning slot 22 is hollow within the rod body of the pushing rod 20 and the positioning screw element 16 can be installed. In combination with the ring element 23 mounted to the lower edge of the ratchet teeth ring face 17 the bottom section is mounted with the massaging head 24. An appropriate length of positioning rod 25 is extended from the center of the bottom section. The shape of the conic sectional of the positioning rod 25 is similar to that of the hollow slot 22, or has corresponding insertion side faces so that it can be inserted into the slot 22 at the bottom end of the pushing rod 20, when the massaging head 24 rotates, the pushing rod 20 rotates simultaneously. The ratchet teeth face 26 at the top end of the ring element 23 can engage with the ratchet teeth ring face 17 so that a fixed direction control is obtain. When the pushing rod 20 of the massage head 24 operates to squeeze a lotion, only a fixed direction of squeezing is possible.

In applying the massaging of the device of the present invention, the massaging head 24 can massage the body and the lotion that squeezed by rotating of the massage head 24 to drive the pushing rod 20 the elastic valve plate 13 elastically seals the outlet head 11. When a force is applied to squeeze the lotion, excessive pressure will cause a deformation to the elastic valve 13 and the portion beyond the outlet hole 141 will retract. When the internal pressure is balance, the valve plate 13 will restore and seal the outlet edge.

In accordance with the present invention, a fixed amount of lotion for massaging is released, and each operation is independent and the valve plate 13 will close automatically and the internal pressure is always kept constant.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A massaging device structure having a tubular body containing a lotion, with an outlet end head at one end of the tubular body and a massaging end at other end, characterized in that a flowing tube is mounted within the outlet end head and is connected to the interior of the tubular body, one side of the tubular body is an outlet opening with an elastic valve plate being used as a stepped-like sealing cap, the inner edge of the lower section of the tubular body is provided with a positioning screw element by means of an engaging ring face, the inner bottom edge face of the screw element is protruded with a ratchet teeth face which mounted with a ring element having a bottom end mounted to the inner bottom portion of the massaging end, and the inner bottom portion of the massaging end is protruded with a positioning rod and is inserted into a hollow slot of a pushing rod to allow pushing rod to be rotated, the ratchet teeth face of the elastic ring element and the ratchet teeth face of the positioning screw element are in engagement such that when the pushing rod is rotated to move up to discharge a solution, the valve plate is retracted and a fixed amount of lotion is squeezed, when there is no squeezing action of the valve plate restores to its position and sealed the outlet.

2. The massaging device structure as claimed in claim 1, wherein the cross section of the positioning rod is similar to the shape of the hollow slot of the pushing rod and with similar or corresponding engaging side face.
